(19) United States
(12) Patent Application Publication
(10) Pub. No.: US 2008/0257908 A1
(43) Pub. Date: Oct. 23, 2008

(54) LIQUID DISPENSING DEVICE

(76) Inventor: Eugene A. Reelick, Bethel, CT (US)

Correspondence Address: EDWARD M. LIVINGSTON, PA, 963 TRAIL TERRACE DRIVE, NAPLES, FL, 34103, US

(21) Appl. No.: 11/738,891

(22) Filed: Apr. 23, 2007

(51) Int. Cl. B67D 5/01

(52) U.S. Cl. 222/63

(57) ABSTRACT

A liquid dispensing device (1) having an elongated handle (2) with a distal end (3) and a proximal end (4), a bottle retaining housing (5) located on the handle (2) for the acceptance of a liquid-filled bottle (6), an electric motor (7), a trigger (15) in electrical connection with the motor (7), a pump (15) located within the bottle retaining housing (5) and in electrical connection with the electric motor (7) wherein the pump (8) is in fluid connection with the liquid (14), a spray nozzle (9) in fluid connection with the pump (8) via a conduit (10), an open and closeable valve (11), a spray pattern adjustment control (12) located proximate to the spray nozzle (9), a spray pattern adjustment control (12) and a removable wheel (13) located on the distal end (3) of the handle (2). The liquid dispensing device is operational when an electrical current is supplied to the motor (7) to create a predetermined amount of pressure to open the valve (11) and permit a predetermined amount of liquid (14) to flow from the bottle (6) and exit through the nozzle (9).

### BACKGROUND OF THE INVENTION

This invention relates to liquid dispensing devices, more particularly, a liquid dispensing device that permits a user to quickly and easily dispense a liquid onto a surface.

Currently, many individuals use hand-held pump reservoir systems to spray liquid fertilizer and/or pesticides on a lawn. The user adds a predetermined amount of liquid to the reservoir, secures a cap thereon, pressurizes the reservoir and sprays the liquid onto the lawn. However, many individuals find the use of such reservoirs difficult as the user must carry the reservoir over the entire area to be sprayed and must repeatedly pump the reservoir to provide a predetermined amount of pressure to spray the liquid. Moreover, because the reservoir is filled with liquid, the user tires easily due to the weight he/she must carry while spraying the lawn. In addition, the entire system is cumbersome to carry due to the bulk of the reservoir.

Moreover, many individuals utilize the same hand-held pump reservoir systems to spray a liquid ice-melter solution onto iced-over sidewalks, driveways and other grounds during the winter to remove ice. For the aforementioned reasons, however, many individuals find using such a system difficult.

Thus, a need exists for a liquid dispensing device that permits a user to quickly and easily dispense liquid onto a surface.

The relevant prior art includes the following references:

| U.S. Pat. No. | | |
|---|---|---|
| (U.S. unless stated otherwise) | Inventor | Issue/Publication Date |
| 4,408,720 | Anderson et al. | Oct. 11, 1983 |
| 6,805,304 | Nokes et al. | Oct. 19, 2004 |
| 6,279,838 | Sivells et al. | Aug. 28, 2001 |
| 6,135,361 | Grassi | Oct. 24, 2000 |
| 5,946,851 | Adey et al. | Sep. 07, 1999 |
| 2004/0084552 | Huartson | May 06, 2004 |
| 5,695,121 | Stillions, Jr. et al. | Dec. 09, 1997 |
| 4,524,912 | Jones | Jun. 25, 1985 |
| 4,865,255 | Luvisotto | Sep. 12, 1989 |
| 5,752,661 | Lewis | May 19, 1998 |
| 6,663,306 | Policicchio et al. | Dec. 16, 2003 |

### SUMMARY OF THE INVENTION

The primary object of the present invention is to provide a liquid dispensing device that permits a user to quickly dispense liquid onto a surface.

Another object of the present invention is to provide a liquid dispensing device that is easy to use.

A further object of the present invention is to provide a liquid dispensing device that is easily portable.

An even further object of the present invention is to provide a liquid dispensing device that is self-contained electrically-powered.

Another object of the present invention is to provide a liquid dispensing device that may be used in conjunction with a variety of liquids.

An even further object of the present invention is to provide a liquid dispensing device that allows for integrated pest management wherein a small amount of liquid is discharged, thereby preventing waste and/or pollution.

The present invention fulfills the above and other objects by providing a liquid dispensing device having an elongated handle, which may be adjustable telescopically, having a proximal end and a distal end, a bottle retaining housing located on the handle for the acceptance of a liquid-filled bottle, an electric motor located within the bottle retaining housing, the bottle retaining housing having a receiving means for acceptance of a bottle opening, a trigger in electrical connection with the motor and located on the proximal end of the handle, a pump located within the bottle retaining housing and in electrical connection with the electric motor wherein the pump is in fluid connection with the predetermined amount of liquid in the bottle, a spray nozzle located on the distal end of the handle and in fluid connection with the pump via a conduit, an open and closeable valve located in the conduit between the spray nozzle and the pump, a spray pattern adjustment control located proximate to the spray nozzle, a spray pattern adjustment means located within the spray nozzle and a removable wheel located on the distal end of the handle. The liquid dispensing device is operational when an electrical current is supplied to the motor to create a predetermined amount of pressure to open the valve and permit a predetermined amount of liquid to flow from the bottle and exit through the nozzle. A voltage source, such as batteries located in a battery housing on the proximal end of the handle so as to have the liquid dispensing device completely self-contained and portable, provides power to the electric motor.

To use the liquid dispensing device of the present invention, a person opens a bottle filled with a predetermined liquid, such as liquid fertilizer, pesticide, herbicide, ice-melt, etc., and inserts the bottle into the bottle retaining house wherein the bottle opening is facing the distal end of the handle. Then, the user pushes a safety button located on the proximal end of the handle and pulls the trigger to spray the liquid onto a surface. The user may then roll the liquid dispensing device of the present invention along the surface to spray the desired surface area. Finally, the user may adjust the spray pattern of the spray nozzle by manipulating the spray pattern adjustment control. The adjustment of the spray pattern is ideal for difficult to reach surface areas, such as stairs, corners or areas located beneath or behind vegetation.

If the user desires to elongate or shorten the handle, then he or she presses a length adjustment button located on the handle. In this manner, the user is better able to reach various surfaces of varying distances from the location of the user.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of a liquid dispensing device of the present invention;

FIG. 2 is a front view of a liquid delivery means of the liquid dispensing device of the present invention;

FIG. 3 is side plan view of a nozzle of the liquid dispensing device of the present invention;

FIG. 4 is a front plan view of a nozzle of the liquid dispensing device of the present invention; and

FIG. 5 is a side view of an alternate embodiment of a liquid dispensing device of the present invention.

### DESCRIPTION OF THE PREFERRED EMBODIMENTS

For purposes of describing the preferred embodiment, the terminology used in reference to the numbered components in the drawings is as follows:
1. liquid dispensing device, generally
2. handle
3. handle distal end
4. handle proximal end
5. bottle retaining housing
6. bottle
7. electric motor
8. pump
9. spray nozzle
10. conduit
11. valve
12. spray pattern adjustment control
13. wheel
14. liquid
15. trigger
16. battery compartment housing
17. electrical connection
18. aperture
19. adjustment disk
20. adjustment means
21. V-shaped pattern
22. linear-shaped pattern
23. circular-shaped pattern
24. liquid delivery means
25. gears
26. safety button
27. length adjustment button
28. inner handle
29. outer handle
30. AC adapter
31. electrical receptacle

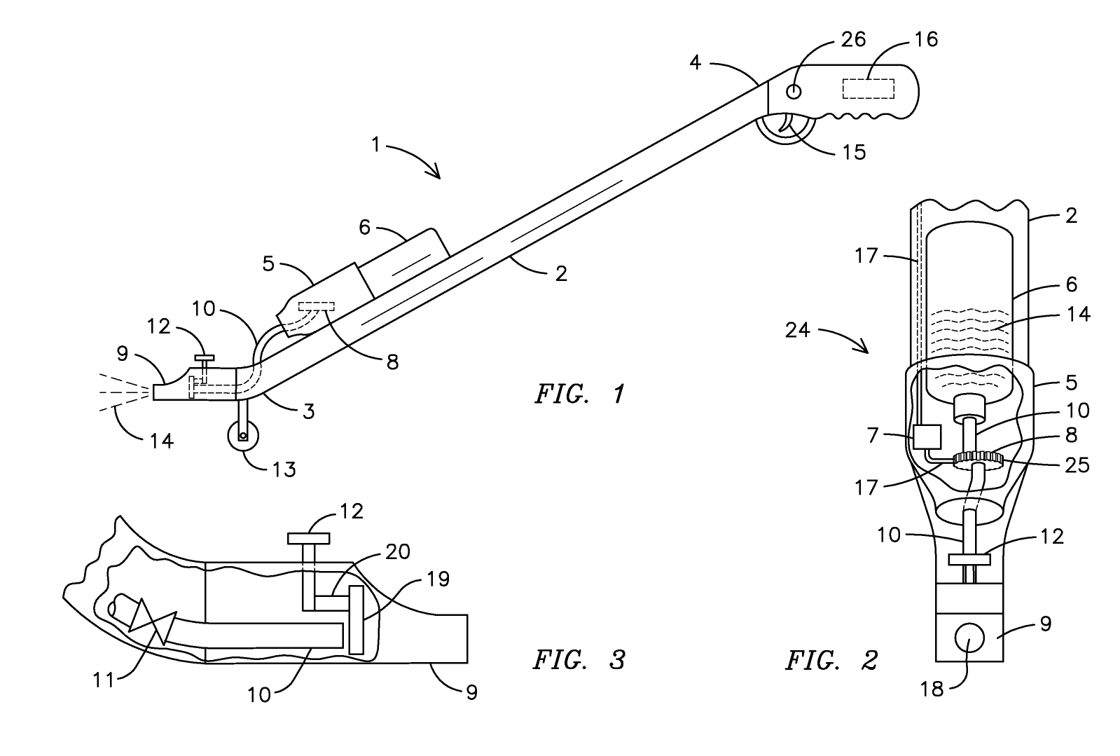

With respect to FIG. 1, a side view of a liquid dispensing device of the present invention is shown. The liquid dispensing device, generally 1, includes an elongated handle 2 having a distal end 3 and a proximal end 4 and a bottle retaining housing 5 secured on the handle 2. The bottle retaining house 5 is sized and shaped so as to receive a bottle 6 containing a liquid 14 therein, which may be pesticide, herbicide, fertilizer, ice-melt or any other liquid in which a user may desire to spray onto a ground surface. A conduit 10 fluidly connects the liquid 14 in the bottle 6 to a pump 8 and fluidly connects the pump 8 to a nozzle 9 located on the handle distal end 3 wherein the liquid 14 is discharged. A spray pattern adjustment control 12 permits a user to select the type of spray pattern which will be emitted from the nozzle 9. A wheel 13, which is preferably removable, is secured to the handle distal end 3 so as to permit a user to quickly and easily move the liquid dispensing device 1 over a surface. To use the present device, a user squeezes the trigger 15 so as to discharge the liquid 14 from the bottle 6 through the nozzle 9 and onto a surface. The liquid dispensing device 1 is electrically-powered via a voltage source, which is preferably rechargeable batteries located within a battery compartment housing 16 located on the handle proximal end 4, so as to be a completely self-contained and portable device. A safety button 26 is preferably located on the handle proximal end 4 so as to prevent liquid 14 from exiting the nozzle 9. In addition, the inclusion of the safety button 26 aids in preventing children from using the liquid dispensing device 1 without adult supervision.

In FIGS. 2 and 3, varying views of a liquid delivery means of the liquid dispensing device of the present invention is shown. The liquid delivery means 24 preferably includes an electric motor 7 located within the bottle retaining housing 5 that is in electrical connection 17 with a voltage source, such as batteries located within the battery compartment housing 16. The electric motor 7 is also in electrical connection 17 with a pump 8 having gears 25. The pump 8 is fluidly-connected to the bottle 6 containing liquid 14 and to the nozzle 9 via conduits 10. A valve 11 is located within the conduit 10 connecting the pump 8 to the nozzle 9 so as to prevent discharging of liquid 14 when the electric motor 7 is not powered. An adjustment means 20 connects the spray pattern adjustment control 12 to an adjustment disk 19 located within the nozzle 9 so as to rotate the adjustment disk 19 when the spray pattern adjustment control 12 is turned.

When the trigger 15 is squeezed, power is provided from a voltage source to the electric motor 7, which in turn activates the pump 8. When the pump 8 is activated, the gears 25 of the pump 8 rotate to generate a pressure sufficient to open the valve 11 so that the liquid 14 can flow through the nozzle 9 and exit via the aperture 18.

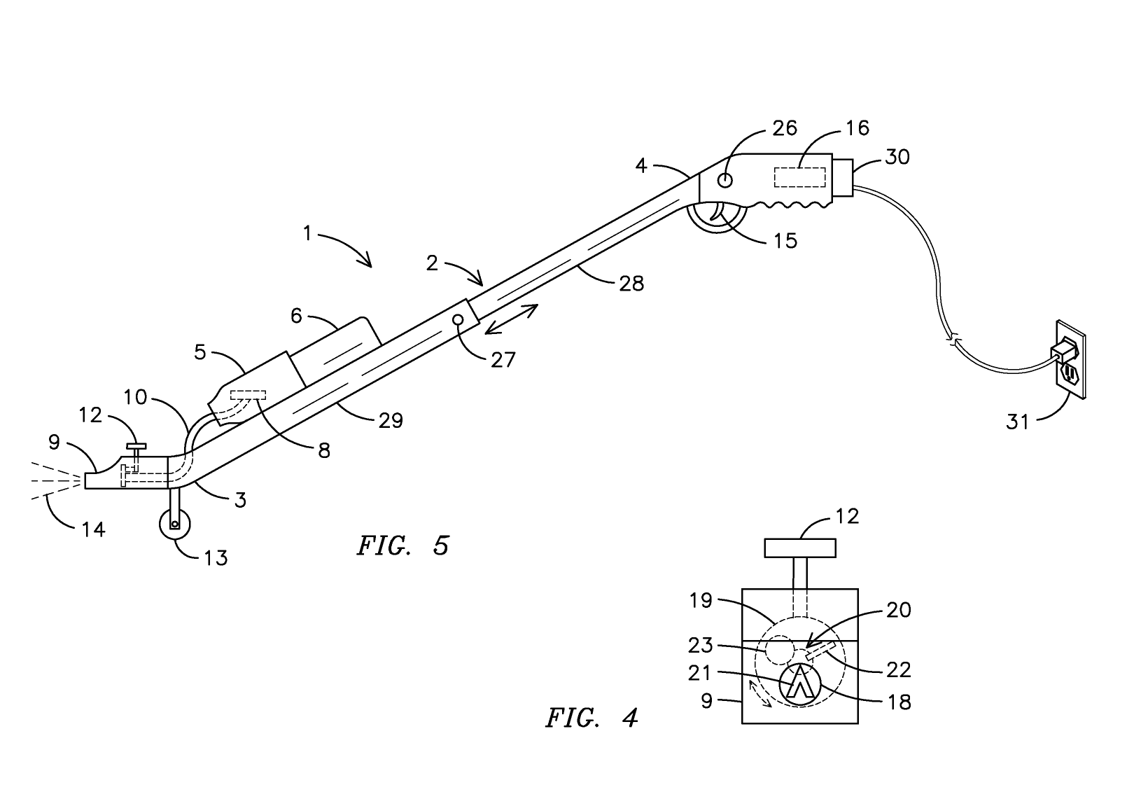

Next, FIG. 4 is a front plan view of a nozzle of the liquid dispensing device of the present invention. The nozzle 9 includes an aperture 18 to permit discharge of the liquid 14. Located within the nozzle 9 is the adjustment disk 19, which preferably includes a plurality of differently-shaped patterns, such as a V-shaped pattern 21 to create a fan-shaped discharge of the liquid 14, a linear-shaped pattern 22 and a circular-shaped pattern 23. When the spray pattern adjustment control 12 is turned, the adjustment means 20 that connects the spray pattern adjustment control 12 to the adjustment disk 19 rotates, so as to rotate the adjustment disk 19 to expose the desired pattern to the aperture 18. When the desired pattern is in line with the aperture 18, the liquid 14 dispersed from the bottle 6 through the nozzle 9 must first pass through the selected pattern, thereby allowing for the discharge of liquid 14 in the desired pattern. The use of predetermined patterns, which include the shapes described above and any others, is especially useful when spraying a surface that is not level, such as in the case of stairs, or includes obstacles, such as trees, flowers or other items located on the surface but not needing to be sprayed.

Finally, FIG. 5 shows a side view of an alternate embodiment of the liquid dispensing device 1 of the present invention. The alternate embodiment includes all of the features noted above. However, the handle 2 of the alternate embodiment is adjustable telescopically so as to permit a user to access various surface areas of varying distances from the user. The handle 2 includes an inner handle 28 and an outer handle 29 wherein the inner handle 28 is retractable within the outer handle 29. A length adjustment button 27, which is preferably located on the handle 2 but may be located elsewhere on the liquid dispensing device 1, permits a user to adjust the length of the handle 2 by pressing the length adjustment button 27 and pushing or pulling the inner handle 28 into or out of the outer handle 29. In addition, the alternate embodiment may include an AC adapter 30 which may be plugged into an electrical receptacle 31 so as to provide a power supply to the liquid dispensing device 1.

The use of the present invention will permit a person to quickly and easily dispense a liquid onto a surface.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A liquid dispensing device comprising:
an elongated handle having a proximal end and a distal end;
a bottle retaining housing located on the handle;
an electric motor located within the bottle retaining housing;
a bottle having a predetermined amount of liquid therein;
the bottle retaining housing having a receiving means for acceptance of a bottle opening;
a trigger located on the proximal end of the handle;
said trigger in electrical connection with the electric motor;
a pump located within the bottle retaining housing and in electrical connection with the electric motor;
said pump in fluid connection with the predetermined amount of liquid in the bottle;
a spray nozzle located on the distal end of the handle and in fluid connection with the pump via a conduit;
an open and closeable valve located in the conduit between the spray nozzle and the pump;
a spray pattern adjustment control located proximate to the spray nozzle;
an adjustment means located within the spray nozzle and operable via the spray pattern adjustment control;
said pump is operational when an electrical current is supplied to the motor to create a predetermined amount of pressure to open the valve and permit a predetermined amount of liquid to flow from the bottle and exit through the nozzle;
a removable wheel located on the distal end of the handle; and
a voltage source for providing power to the electric motor.

2. The liquid dispensing device of claim 1 wherein:
said liquid is a pesticide.

3. The liquid dispensing device of claim 1 wherein:
said liquid is a herbicide.

4. The liquid dispensing device of claim 1 wherein:
said liquid is an ice-melter.

5. The liquid dispensing device of claim 1 wherein:
said liquid is a fertilizer.

6. The liquid dispensing device 1 wherein:
said voltage source is at least one battery.

7. The liquid dispensing device of claim 1 wherein:
said voltage source is an AC adapter which may be plugged into an electrical receptacle.

8. The liquid dispensing device of claim 1 wherein:
said spray pattern adjustment control creates a circular spray pattern.

9. The liquid dispensing device of claim 1 wherein:
said spray pattern adjustment control creates a linear spray pattern.

10. The liquid dispensing device of claim 1 wherein:
said spray pattern adjustment control creates a V-shaped spray pattern.

11. The liquid dispensing device of claim 1 further comprising:
a safety button located on the proximal end of the handle wherein the safety button prevents liquid from exiting the nozzle.

12. The liquid dispensing device of claim 6 wherein:
said at least one battery is located within a battery housing on the proximal end of the handle.

13. The liquid dispensing device of claim 7 wherein:
said AC adapter is located within a battery housing on the proximal end of the handle.

14. The liquid dispensing device of claim 12 wherein:
the at least one battery is rechargeable.

15. A liquid dispensing device comprising:
an elongated handle having a proximal end and a distal end;
a bottle retaining housing located on the handle;
an electric motor located within the bottle retaining housing;
a bottle having a predetermined amount of liquid pesticide therein;
the bottle retaining housing having a receiving means for acceptance of a bottle opening;
a trigger located on the proximal end of the handle;
said trigger in electrical connection with the electric motor;
a pump located within the bottle retaining housing and in electrical connection with the electric motor;
said pump in fluid connection with the predetermined amount of liquid in the bottle;
a spray nozzle located on the distal end of the handle and in fluid connection with the pump via a conduit;
an open and closeable valve located in the conduit between the spray nozzle and the pump;
a spray pattern adjustment control located proximate to the spray nozzle;
an adjustment means located within the spray nozzle and operable via the spray pattern adjustment control;
said pump is operational when an electrical current is supplied to the motor to create a predetermined amount of pressure to open the valve and permit a predetermined amount of liquid to flow from the bottle and exit through the nozzle;
a removable wheel located on the distal end of the handle; and
a voltage source located on the handle second end for providing power to the electric motor wherein the voltage source is at least one battery.

16. The liquid dispensing device of claim 15 wherein:
said at least one battery is rechargeable.

17. A liquid dispensing device comprising:
an elongated handle having a proximal end and a distal end;
a bottle retaining housing located on the handle;
an electric motor located within the bottle retaining housing;
a bottle having a predetermined amount of liquid therein;
the bottle retaining housing having a receiving means for acceptance of a bottle opening;
a trigger located on the proximal end of the handle;
said trigger in electrical connection with the electric motor;
a pump located within the bottle retaining housing and in electrical connection with the electric motor;
said pump in fluid connection with the predetermined amount of liquid in the bottle;
a spray nozzle located on the distal end of the handle and in fluid connection with the pump via a conduit;
an open and closeable valve located in the conduit between the spray nozzle and the pump;
a spray pattern adjustment control located proximate to the spray nozzle;
an adjustment means located within the spray nozzle and operable via the spray pattern adjustment control;
said spray pattern adjustment control creates a linear spray pattern, a V-shaped spray pattern and a circular pattern;
said spray pattern adjustment control creates a circular spray pattern;
said pump is operational when an electrical current is supplied to the motor to create a predetermined amount of pressure to open the valve and permit a predetermined amount of liquid to flow from the bottle and exit through the nozzle;
a removable wheel located on the distal end of the handle; and
a voltage source located on the handle second end for providing power to the electric motor wherein the voltage source is at least one battery.

18. The liquid dispensing device of claim 15 wherein:
said elongated handle is telescopic wherein an inner handle is extendable from an outer handle.

19. The liquid dispensing device of claim 17 wherein:
said elongated handle is telescopic wherein an inner handle is extendable from an outer handle.
